(19) United States
(12) Patent Application Publication
(10) Pub. No.: US 2025/0144543 A1
(43) Pub. Date: May 8, 2025

(54) SOLUTION CIRCULATION CONCENTRATING DEVICE WITH HIGH SOLAR ENERGY UTILIZATION EFFICIENCY AND CONCENTRATING METHOD USING THE SAME

(71) Applicant: SICHUAN HUIWEI RONGDA TECHNOLOGY CO., LTD, MIANYANG CITY (CN)

(72) Inventors: WEI ZHANG, MIANYANG CITY (CN); XIAOHUI LIU, MIANYANG CITY (CN)

(21) Appl. No.: 18/394,816

(22) Filed: Dec. 22, 2023

(30) Foreign Application Priority Data
Nov. 8, 2023 (CN) 2023114850443

(51) Int. Cl. B01D 1/22; B01D 1/00; B01D 1/20; B01D 29/56; B01D 36/00; C02F 1/00; C02F 1/08; C02F 1/12; C02F 1/14; C02F 103/00

(52) U.S. Cl. CPC B01D 1/223; B01D 1/0035; B01D 1/0094; B01D 1/20; B01D 29/56; B01D 36/00; C02F 1/004; C02F 1/08; C02F 1/12; C02F 1/14; C02F 2103/001; C02F 2301/08

(57) ABSTRACT

A solution circulation concentrating device with high solar energy utilization efficiency and a concentrating method using the same are provided, and relate to the technical field of solution concentration equipment. The device includes a concentrated solution collecting tray, an evaporator, a rotation driving device, a liquid inlet pipe, a liquid outlet pipe, a liquid storage tank, a filter tank, and a rainwater discharge pipe. The concentrated solution collecting tray is rotatably connected with the evaporator. The evaporator is connected with the rotation driving device. The rotation driving device is configured for driving the evaporator to rotate. The liquid inlet pipe and the liquid outlet pipe are arranged at the concentrated solution collecting tray. The liquid inlet pipe is configured to pass through the evaporator.

### CROSS-REFERENCE TO RELATED APPLICATION

This patent application claims the benefit and priority of Chinese Patent Application No. 2023114850443 filed with the China National Intellectual Property Administration on Nov. 8, 2023, the disclosure of which is incorporated by reference herein in its entirety as part of the present application.

### TECHNICAL FIELD

The present disclosure relates to the technical field of solution concentration equipment, in particular to a solution circulation concentrating device with high solar energy utilization efficiency and a concentrating method using the same.

### BACKGROUND

Concentration technology is a technology widely used in industrial production. The use of solar energy for solution concentration has a long history. For example, this technology is used to dry salt on the mudflat. However, this traditional solution concentration technology using solar energy requires a large floor area, and is difficult to be applied to modem industrial production.

With the continuous development of technology, there are some equipment to realize concentration technology by using solar energy in the prior art, such as a solar circulating evaporation concentrating device proposed in Chinese Patent CN204563628U, or a concentrating device based on solar heating proposed in Chinese Patent CN204307377U.

The above patents can realize the concentration of the utilized solution, but during the actual use process, due to the constantly changing direction of sunlight irradiation and each evaporation device in the above two devices cannot realize the technical effect of rotation, there is a problem of low solar energy utilization efficiency.

Therefore, there is an urgent need in this field for a solution circulation concentrating device with high solar energy utilization efficiency and a concentrating method using the same to solve the above problems.

### SUMMARY

The purpose of the present disclosure is to provide a solution circulation concentrating device with high solar energy utilization efficiency and a concentrating method using the same to solve the technical problems existing in the prior art. The evaporator can be kept rotating through the rotation driving device, so that the irradiation time of the sun to the evaporator is increased, and the work efficiency of solution concentration is increased.

In order to achieve the purpose, the present disclosure provides the following solution.

Disclosed is a solution circulation concentrating device with high solar energy utilization efficiency, including a concentrated solution collecting tray, an evaporator, a rotation driving device, a liquid inlet pipe, a liquid outlet pipe, a liquid storage tank, a filter tank, and a rainwater discharge pipe. The concentrated solution collecting tray is rotatably connected with the evaporator. The evaporator is connected with the rotation driving device. The rotation driving device is configured for driving the evaporator to rotate.

The liquid inlet pipe and the liquid outlet pipe are arranged at the concentrated solution collecting tray. The liquid inlet pipe is configured to pass through the evaporator. A liquid outlet of the liquid inlet pipe is located at an upper end of the evaporator. A liquid inlet of the liquid outlet pipe is located on a surface of the concentrated solution collecting tray. A liquid outlet of the liquid outlet pipe and a liquid inlet of the liquid inlet pipe are connected to the liquid storage tank, respectively. The filter tank is arranged on the liquid outlet pipe.

The concentrated solution collecting tray is connected with the rainwater discharge pipe, and the rainwater discharge pipe is configured for discharging rainwater.

Optionally, the evaporator is of a conical structure. Multiple annular evaporator grooves are formed in a side wall of the evaporator. An outer surface of the side wall of the evaporator is coated with a solar heat adsorption coating.

Optionally, a spray head is arranged at the liquid outlet of the liquid inlet pipe.

Optionally, the rotation driving device includes a rotating cylinder and a driving motor. The rotating cylinder is fixed at a lower end of the evaporator, the rotating cylinder is configured to pass through the concentrated solution collecting tray, and the rotating cylinder is in transmission connection with an output shaft of the driving motor via a transmission belt.

Optionally, the rotating cylinder is fixedly connected with the evaporator via multiple connecting rods.

Optionally, an annular groove is formed in an outer side wall of the rotating cylinder. A belt pulley is arranged on the output shaft of the driving motor. Both sides of the transmission belt are engaged with the annular groove and the belt pulley, respectively.

Optionally, multiple universal wheels are arranged below the evaporator, and the universal wheels are capable of rotating on the concentrated solution collecting tray.

Optionally, multiple filter screens are arranged in the filter tank in sequence.

Optionally, a circulating pump and a liquid inlet valve are arranged on the liquid inlet pipe.

A liquid outlet valve is arranged on the liquid outlet pipe.

A rainwater discharge valve is arranged on the rainwater discharge pipe.

The present disclosure also provides a concentrating method based on the above solution circulation concentrating device with high solar energy utilization efficiency, including:
during normal operation, closing the rainwater discharge pipe, opening the liquid inlet pipe and the liquid outlet pipe, enabling solution in the liquid storage tank to flow in from the liquid inlet of the liquid inlet pipe, and then enabling the solution to flow out from the liquid outlet of the liquid inlet pipe and be sprayed onto the evaporator; during this process, driving the evaporator to keep rotating by the rotation driving device, and enabling the solution flowing out of the evaporator to flow back into the liquid storage tank through the liquid outlet pipe, so that a concentration cycle is completed; repeating the concentration cycle several times until the solution in the liquid storage tank reaches an expected concentration;
when it rains, closing the liquid inlet pipe and the liquid outlet pipe, opening the rainwater discharge pipe, and enabling rainwater in the concentrated solution collecting tray to flow out from the rainwater discharge pipe.

Compared with the prior art, the present disclosure has the following technical effects.

Firstly, the rotating evaporator can collect solar energy to the maximum extent in the sunshine irradiation with constantly changing direction.

Secondly, solar energy can be converted into heat energy through the solar heat adsorption coating to evaporate water in the concentrated solution to a greater extent.

Thirdly, the annular evaporator grooves formed on the outer surface of the evaporator can increase the surface area of the evaporator to increase the maximum sunlight irradiation area and increase the evaporation speed.

Fourthly, the evaporator can be driven to rotate by only one driving motor without other energy sources, so the device has the advantages of environmental protection, energy saving, high efficiency, land saving and the like.

### BRIEF DESCRIPTION OF THE DRAWINGS

To more clearly illustrate the present embodiments of the present disclosure or the technical solution in the prior art, the following briefly introduces the attached figures to be used in the present embodiments. Apparently, the attached figures in the following description show merely some embodiments of the present disclosure, and those skilled in the art may still obtain other figures from these attached figures without creative efforts.

FIG. 1 is a structural schematic diagram of a solution circulation concentrating device with high solar energy utilization efficiency in an embodiment of the present disclosure; and

FIG. 2 is a front view of an evaporator in the solution circulation concentrating device with high solar energy utilization efficiency in the embodiment of the present disclosure.

Reference signs: 1 evaporator; 2 rotating cylinder; 3 concentrated solution collecting tray; 4 spray head; 5 liquid inlet pipe; 6 liquid outlet pipe; 7 liquid storage tank; 8 circulating pump; 9 filter tank; 10 liquid inlet valve; 11 liquid outlet valve; 12 driving motor; 13 transmission belt; 14 rainwater discharge pipe; 15 rainwater discharge valve; 16 connecting rod; 17 universal wheel; and 18 clamping bearing.

### DETAILED DESCRIPTION OF THE EMBODIMENTS

The following clearly and completely describes the technical solution in the embodiments of the present disclosure with reference to the embodiments of the present disclosure. Apparently, the described embodiments are merely a part rather than all of the embodiments of the present disclosure. Based on the embodiments in the present disclosure, all other embodiments obtained by the ordinary technical staff in the art without creative efforts belong to the scope protected by the present disclosure.

The purpose of the present disclosure is to provide a solution circulation concentrating device with high solar energy utilization efficiency and a concentrating method using the same to solve the technical problems existing in the prior art. The evaporator can be kept rotating through the rotation driving device, so that the irradiation time of the sun to the evaporator is increased, and the work efficiency of solution concentration is increased.

To make the foregoing objective, features and advantages of the present disclosure clearer and easier to understand, the present disclosure is further described in detail below with reference to the attached figures and specific embodiments.

### Embodiment I

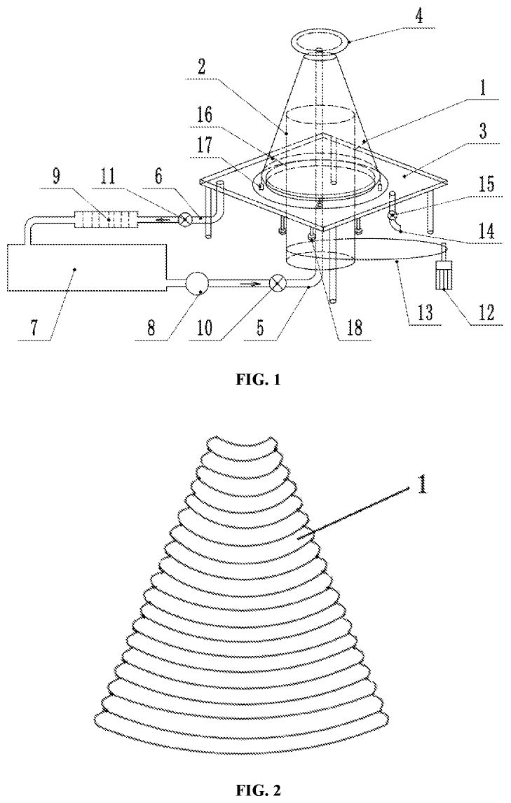

As shown in FIG. 1 to FIG. 2, the embodiment provides a solution circulation concentrating device with high solar energy utilization efficiency. The solution circulation concentrating device includes a concentrated solution collecting tray 3. The concentrated solution collecting tray 3 is of a rectangular desktop-shaped structure. Baffles are arranged around the concentrated solution collecting tray 3 to prevent the concentrated solution from flowing out of the concentrated solution collecting tray 3. Legs are arranged at four corners below the concentrated solution collecting tray 3 to support the concentrated solution collecting tray 3. The concentrated solution collecting tray 3 is rotatably connected with an evaporator 1. The evaporator 1 is connected with a rotation driving device. The rotation drying device is configured for driving the evaporator 1 to rotate on the concentrated solution collecting tray 3.

A liquid inlet pipe 5 and a liquid outlet pipe 6 is arranged at the concentrated solution collecting tray 3. A liquid outlet of the liquid inlet pipe 5 passes through the evaporator 1, and a liquid outlet of the liquid inlet pipe 5 is located at an upper end of the evaporator 1. A liquid inlet of the liquid outlet pipe 6 is located on a surface of the concentrated solution collecting tray 3, and is flush with or slightly lower than an upper surface of the concentrated solution collecting tray 3, so that the concentrated solution on the concentrated solution collecting tray 3 can flow out from the liquid inlet of the liquid outlet pipe 6. A liquid outlet of the liquid outlet pipe 6 and a liquid inlet of the liquid inlet pipe 5 are connected to a liquid storage tank 7, respectively. The concentrated solution is stored in and taken out at the liquid storage tank 7. A filter tank 9 is arranged at the liquid outlet pipe 6. The filter tank 9 is used for filtering some crystals and impurities falling onto the concentrated solution collecting tray 3.

The concentrated solution collecting tray 3 is connected with a rainwater discharge pipe 14. A water inlet at the upper end of the rainwater discharge pipe 14 is flush with or lower than the upper surface of the concentrated solution collecting tray 3. The rainwater discharge pipe 14 is configured for discharging rainwater. Finally, rainwater can flow out from a water outlet at the lower end of the rainwater discharge pipe 14. Of course, a collection bucket can also be arranged below the rainwater discharge pipe 14, so that rainwater can be collected.

In actual use, liquid to be concentrated is first poured into the liquid storage tank 7, and then the liquid inlet pipe 5 and the liquid outlet pipe 6 are opened, and the rainwater discharge pipe 14 is closed. The solution in the liquid storage tank 7 flows in from the liquid inlet of the liquid inlet pipe 5, and then flows out from the liquid outlet of the liquid inlet pipe 5 and is sprayed onto the evaporator 1. During this process, the evaporator 1 can be driven to keep rotating by the rotation driving device, so that the concentrated solution can fully flow throughout the entire evaporator 1, and the irradiation time of sunlight can be effectively increased. The solution flowing out of the evaporator 1 flows into the liquid outlet pipe 6, then flows out of the liquid outlet pipe 6 and back into the liquid storage tank 7, so that a concentration cycle is completed. Then the concentration cycle is repeated several times until the solution in the liquid storage tank 7 reaches an expected concentration, and finally, the concentrated solution with the expected concentration is taken out from the liquid storage tank 7.

When it rains, the liquid inlet pipe 5 and the liquid outlet pipe 6 are closed, the rainwater discharge pipe is opened, and rainwater in the concentrated solution collecting tray 3 flows out from the rainwater discharge pipe 14.

In the embodiment, the evaporator 1 is a barrel of a conical structure. The diameter of the evaporator 1 is gradually increased from top to bottom. Multiple annular evaporator grooves are formed in the side wall of the evaporator 1. The purpose of forming the annular evaporator grooves is to increase the surface area of the evaporator 1, so that the concentrated solution can stay on the surface of the evaporator 1 for a longer period of time, and the concentration effect is improved. The outer surface of the side wall of the evaporator 1 is coated with a solar heat adsorption coating, so that solar energy can be converted into heat energy to evaporate water in the concentrated solution to a greater extent.

In the embodiment, a spray head 4 is arranged at the liquid outlet of the liquid inlet pipe 5. The spray head 4 can be a commercially available spray head, or a container in which multiple holes are formed. The role of the spray head 4 is to uniformly spray the concentrated solution from the liquid inlet pipe 5 onto various positions on the evaporator 1.

In the embodiment, the rotation driving device includes a rotating cylinder 2 and a driving motor 12. The rotating cylinder 2 is fixed at the lower end of the interior of the evaporator 1. The rotating cylinder 2 passes through the concentrated solution collecting tray 3. It can be understood that a corresponding central through hole is formed in the concentrated solution collecting tray 3, and a barrier structure extending upwards is further arranged at the edge of the central through hole to avoid the concentrated solution from flowing out through the central through hole. The rotating cylinder 2 is in transmission connection with the output shaft of the driving motor 12 via a transmission belt 13. In actual use, the driving motor 12 is started to drive the rotating cylinder 2 to rotate through the transmission belt 13.

It should be noted that the driving motor 12 can be an existing slow motor, and the driving motor 12 is configured for rotating the rotating cylinder 2 at a speed of 0.5 r/min to 10 r/min. This arrangement has the advantage of preventing the concentrated solution from being thrown out and reducing the energy consumption.

Furthermore, in order to avoid radial shaking of the rotating cylinder 2 during operation, three clamping rods are arranged below the concentrated solution collecting tray 3, and a clamping bearing 18 is arranged at the lower end of each clamping rod. Three clamping bearings 18 are uniformly arranged at the outer circumference of the rotating cylinder 2, and the radial direction of the rotating cylinder 2 can be limited by the three clamping bearings 18, so that the rotating cylinder 2 is prevented from moving left and right.

In the embodiment, the rotating cylinder 2 is fixedly connected with the evaporator 1 through multiple connecting rods 16. Specifically, two connecting rods 16 are provided. Both ends of each connecting rod 16 are welded to the inner wall of the evaporator 1 and the outer wall of the rotating cylinder 2, respectively. Of course, according to the actual situation, those skilled in the art can also provide three or more than three connecting rods 16.

In the embodiment, an annular groove is formed in the outer side wall of the rotating cylinder 2. A belt pulley is arranged on the output shaft of the driving motor 12. Both sides of the transmission belt 13 are engaged with the annular groove and the belt pulley, respectively. When the driving motor 12 is started, the output shaft of the driving motor 12 can drive the belt pulley to rotate, and the belt pulley can drive the rotating cylinder 2, in which the annular groove is formed, to rotate through the transmission belt 13, and finally the evaporator 1 is driven to rotate.

In the embodiment, multiple universal wheels 17, specifically three to four universal wheels, are arranged below the evaporator 1. The universal wheels 17 can rotate on the concentrated solution collecting tray 3. Furthermore, an annular slideway is formed in the concentrated solution collecting tray 3, and the universal wheels 17 slide in the annular slideway, so that the evaporator 1 is prevented from shifting left and right during the sliding process of the universal wheels 17. The arrangement of the universal wheels 17 has two advantages. Firstly, the universal wheels 17 can be used for supporting the weight of the evaporator 1 and the rotating cylinder 2. Secondly, friction between the evaporator 1 and the concentrated solution collecting tray 3 can be effectively avoided.

In the embodiment, multiple filter screens are arranged in the filter tank 9 in sequence, and the pore size of each filter screen is gradually decreased along the direction from the liquid inlet to the liquid outlet of the liquid outlet pipe 6. There are two effects of arranging the filter tank 9. Firstly, crystals may be produced during the concentration process, and the filter screens can be used for filtering out the crystals of the concentrated solution. Secondly, because the equipment is used in the open air, some impurities can fall onto the concentrated solution collecting tray 3 and enter the liquid outlet pipe 6 together with the concentrated solution, and the filter screens can effectively filter out these impurities.

In the embodiment, a circulating pump 8 and a liquid inlet valve 10 are arranged on the liquid inlet pipe 5, the circulating pump 8 is configured for providing power for conveying the concentrated solution, and the liquid inlet valve 10 can control the circulation of the liquid inlet pipe 5.

A liquid outlet valve 11 is arranged on the liquid outlet pipe 6. The liquid outlet valve 11 is configured for controlling the circulation of the liquid outlet pipe 6.

A rainwater discharge valve 15 is arranged on the rainwater discharge pipe 14. The rainwater discharge valve 15 is configured for controlling the circulation of the rainwater discharge pipe 14.

The liquid inlet valve 10, the liquid outlet valve 11, or the rainwater discharge valve 15 may be either a manual valve or an electric valve, preferably an electric valve, for remote control by a worker.

In addition, a controller can be provided to be electrically connected with the liquid inlet valve 10, the liquid outlet valve 11, the rainwater discharge valve 15, the circulating pump 8 and the driving motor 12, so that remote control of the worker can be realized. The controller can be a single-chip microcomputer controller or a PLC (Programmable Logic Controller) controller.

### Embodiment II

The embodiment provides a concentrating method based on the solution circulation concentrating device with high solar energy utilization efficiency in embodiment I, including the following steps.

During normal operation, a low-concentration solution is first poured into the liquid storage tank 7, the rainwater discharge pipe 15 on the rainwater discharge pipe 14 is closed, and the liquid inlet valve 10 on the liquid inlet pipe 5 and the liquid outlet valve 11 on the liquid outlet pipe 6 are opened; solution in the liquid storage tank 7 flows in from the liquid inlet of the liquid inlet pipe 5, and then flows out from the liquid outlet of the liquid inlet pipe 5 and be sprayed onto the evaporator 1 through the spray head 4 to form a liquid film. During this process, the evaporator 1 can be driven to keep rotating by the rotation driving device, and the solution flowing out of the evaporator 1 can flow back into the liquid storage tank 7 through the liquid outlet pipe 6, so that a concentration cycle is completed. The concentration of the concentrated solution is increased after a concentration cycle. The concentration cycle is repeated several times until the solution in the liquid storage tank 7 reaches an expected concentration, and finally the concentrated solution is taken out from the liquid storage tank 7.

When it rains, the liquid inlet valve 10 on the liquid inlet pipe 5 and the liquid outlet valve 11 on the liquid outlet pipe 6 are closed, the rainwater discharge valve 15 on the rainwater discharge pipe 14 is opened, and rainwater in the concentrated solution collecting tray 3 can flow out through the rainwater discharge pipe 14, so that the rainwater can be collected to avoid affecting normal concentration operation.

Specific examples are used for illustration of the principles and implementation methods of the present disclosure. The description of the above-mentioned embodiments is used to help illustrate the method and the core principles of the present disclosure. In addition, those skilled in the art can make various modifications in terms of specific embodiments and scope of application in accordance with the teachings of the present disclosure. In summary, the contents of this specification should not be understood as the limitation of the present disclosure.

1. A solution circulation concentrating device with high solar energy utilization efficiency, comprising a concentrated solution collecting tray, an evaporator, a rotation driving device, a liquid inlet pipe, a liquid outlet pipe, a liquid storage tank, a filter tank, and a rainwater discharge pipe,
wherein the concentrated solution collecting tray is rotatably connected with the evaporator, the evaporator is connected with the rotation driving device, and the rotation driving device is configured for driving the evaporator to rotate;
the liquid inlet pipe and the liquid outlet pipe is arranged at the concentrated solution collecting tray, the liquid inlet pipe is configured to pass through the evaporator, a liquid outlet of the liquid inlet pipe is located at an upper end of the evaporator, a liquid inlet of the liquid outlet pipe is located on a surface of the concentrated solution collecting tray, a liquid outlet of the liquid outlet pipe and a liquid inlet of the liquid inlet pipe are connected to the liquid storage tank, respectively, and the filter tank is arranged on the liquid outlet pipe;
the concentrated solution collecting tray is connected with the rainwater discharge pipe, and the rainwater discharge pipe is configured for discharging rainwater.

2. The solution circulation concentrating device with high solar energy utilization efficiency according to claim 1, wherein the evaporator is of a conical structure, a plurality of annular evaporator grooves are formed in a side wall of the evaporator, and an outer surface of the side wall of the evaporator is coated with a solar heat adsorption coating.

3. The solution circulation concentrating device with high solar energy utilization efficiency according to claim 1, wherein a spray head is arranged at the liquid outlet of the liquid inlet pipe.

4. The solution circulation concentrating device with high solar energy utilization efficiency according to claim 1, wherein the rotation driving device comprises a rotating cylinder and a driving motor, the rotating cylinder is fixed at a lower end of the evaporator, the rotating cylinder is configured to pass through the concentrated solution collecting tray, and the rotating cylinder is in transmission connection with an output shaft of the driving motor via a transmission belt.

5. The solution circulation concentrating device with high solar energy utilization efficiency according to claim 4, wherein the rotating cylinder is fixedly connected with the evaporator via a plurality of connecting rods.

6. The solution circulation concentrating device with high solar energy utilization efficiency according to claim 4, wherein an annular groove is formed in an outer side wall of the rotating cylinder, a belt pulley is arranged on the output shaft of the driving motor, and both sides of the transmission belt are engaged with the annular groove and the belt pulley, respectively.

7. The solution circulation concentrating device with high solar energy utilization efficiency according to claim 1, wherein a plurality of universal wheels are arranged below the evaporator, and the universal wheels are capable of rotating on the concentrated solution collecting tray.

8. The solution circulation concentrating device with high solar energy utilization efficiency according to claim 1, wherein a plurality of filter screens are arranged in the filter tank in sequence.

9. The solution circulation concentrating device with high solar energy utilization efficiency according to claim 1, wherein a circulating pump and a liquid inlet valve are arranged on the liquid inlet pipe;
a liquid outlet valve is arranged on the liquid outlet pipe;
a rainwater discharge valve is arranged on the rainwater discharge pipe.

10. A concentrating method based on the solution circulation concentrating device with high solar energy utilization efficiency, wherein the solution circulation concentrating device with high solar energy utilization efficiency comprises a concentrated solution collecting tray, an evaporator, a rotation driving device, a liquid inlet pipe, a liquid outlet pipe, a liquid storage tank, a filter tank, and a rainwater discharge pipe,
wherein the concentrated solution collecting tray is rotatably connected with the evaporator, the evaporator is connected with the rotation driving device, and the rotation driving device is configured for driving the evaporator to rotate;
the liquid inlet pipe and the liquid outlet pipe is arranged at the concentrated solution collecting tray, the liquid inlet pipe is configured to pass through the evaporator, a liquid outlet of the liquid inlet pipe is located at an upper end of the evaporator, a liquid inlet of the liquid outlet pipe is located on a surface of the concentrated solution collecting tray, a liquid outlet of the liquid outlet pipe and a liquid inlet of the liquid inlet pipe are connected to the liquid storage tank, respectively, and the filter tank is arranged on the liquid outlet pipe;
the concentrated solution collecting tray is connected with the rainwater discharge pipe, and the rainwater discharge pipe is configured for discharging rainwater;
the concentrating method comprising:
during normal operation, closing the rainwater discharge pipe, opening the liquid inlet pipe and the liquid outlet pipe, enabling solution in the liquid storage tank to flow in from the liquid inlet of the liquid inlet pipe, and then flow out from the liquid outlet of the liquid inlet pipe and be sprayed onto the evaporator; during this process, driving the evaporator to keep rotating by the rotation driving device, and enabling the solution flowing out of the evaporator to flow back into the liquid storage tank through the liquid outlet pipe, so that a concentration cycle is completed; repeating the concentration cycle several times until the solution in the liquid storage tank reaches an expected concentration;
when it rains, closing the liquid inlet pipe and the liquid outlet pipe, opening the rainwater discharge pipe, and enabling rainwater in the concentrated solution collecting tray to flow out from the rainwater discharge pipe.

11. The concentrating method according to claim 10, wherein the evaporator is of a conical structure, a plurality of annular evaporator grooves are formed in a side wall of the evaporator, and an outer surface of the side wall of the evaporator is coated with a solar heat adsorption coating.

12. The concentrating method according to claim 10, wherein a spray head is arranged at the liquid outlet of the liquid inlet pipe.

13. The concentrating method according to claim 10, wherein the rotation driving device comprises a rotating cylinder and a driving motor, the rotating cylinder is fixed at a lower end of the evaporator, the rotating cylinder is configured to pass through the concentrated solution collecting tray, and the rotating cylinder is in transmission connection with an output shaft of the driving motor via a transmission belt.

14. The concentrating method according to claim 13, wherein the rotating cylinder is fixedly connected with the evaporator via a plurality of connecting rods.

15. The concentrating method according to claim 13, wherein an annular groove is formed in an outer side wall of the rotating cylinder, a belt pulley is arranged on the output shaft of the driving motor, and both sides of the transmission belt are engaged with the annular groove and the belt pulley, respectively.

16. The concentrating method according to claim 10, wherein a plurality of universal wheels are arranged below the evaporator, and the universal wheels are capable of rotating on the concentrated solution collecting tray.

17. The concentrating method according to claim 10, wherein a plurality of filter screens are arranged in the filter tank in sequence.

18. The concentrating method according to claim 10, wherein a circulating pump and a liquid inlet valve are arranged on the liquid inlet pipe;
a liquid outlet valve is arranged on the liquid outlet pipe;
a rainwater discharge valve is arranged on the rainwater discharge pipe.
